(19) United States
(12) Patent Application Publication
(10) Pub. No.: US 2020/0413136 A1
(43) Pub. Date: Dec. 31, 2020

(54) Method and Apparatus for Content Control Based on the Number of Viewers

(71) Applicant: Ventech Solutions Inc., Columbus, OH (US)

(72) Inventors: Ravi Kunduru, Columbus, OH (US); Ravi Kiran, Chennai (IN)

(73) Assignee: Ventech Solutions Inc., Columbus, OH (US)

(21) Appl. No.: 16/910,254

(22) Filed: Jun. 24, 2020

Related U.S. Application Data
(60) Provisional application No. 62/866,091, filed on Jun. 25, 2019.

(51) Int. Cl. H04N 21/442; H04N 21/472

(52) U.S. Cl. CPC H04N 21/44218; H04N 21/44204; H04N 21/47211

(57) ABSTRACT

Disclosed herein are methods and system for content control based on the number of viewers and views. The method may include obtaining, by an audience determination device, a number of viewers watching a selected content being played on a display device. A content receiving device may determine if a determined number of viewers exceeds a purchased number of viewers. If the determined number of viewers exceeds the purchased number of viewers, then the playing of the selected content is paused. An error message may be provided so that corrective action may be taken. The playback of the selected content may be resumed when the determined number of viewers does not exceed the purchased number of viewers. In an implementation, the content receiving device may also determine if there any available purchased views for the selected content.

### CROSS-REFERENCE TO RELATED APPLICATION

This application claims priority to and the benefit of U.S. Provisional Patent Application No. 62/866,091, filed Jun. 25, 2019, the entire disclosure of which is hereby incorporated by reference.

### TECHNICAL FIELD

This disclosure relates to streaming content. More specifically, this disclosure relates to monetizing content based on pay per view per person.

### BACKGROUND

In order to receive monetization from every viewer of content, content producers and distributors (collectively “content owners”) would need to restrict the showing of the content to controlled environments, such as movie theaters and the like, where each viewer may be separately charged to see the content. However, this reaches a limited target audience and decreases the revenue generation.

Digital platforms, such as streaming services and pay-per-view, provide content owners an easier and faster way to reach a much larger target audience. However, there does not seem to a mechanism for tracking the number of viewers watching the content and charging each viewer for each viewing of the content. Consequently, content owners are unable to monetize their content libraries.

### SUMMARY

Disclosed herein are methods, apparatus and system for content control based on the number of viewers and number of views. The system constantly monitors the number of views and number of viewers watching the content and stops the content from playing if the number of views or if the number of viewers exceeds a purchased number of views or viewers, respectively. The method may include obtaining, by an audience determination device, a number of viewers watching a selected content being played on a display device. A content receiving device may determine if a determined number of viewers exceeds a purchased number of viewers. If the determined number of viewers exceeds the purchased number of viewers, then the playing of the selected content is paused. An error message may be provided so that corrective action may be taken. The playback of the selected content may be resumed when the determined number of viewers does not exceed the purchased number of viewers. In an implementation, the content receiving device may also determine if there any available purchased views for the selected content.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example architecture of a system in accordance with embodiments of this disclosure.

FIG. 2 is a diagram of an example software architecture of a system in accordance with embodiments of this disclosure.

FIG. 3 is a flowchart of an example method for content control and monetization in accordance with embodiments of this disclosure.

FIG. 4 is a flowchart of another example method for content control and monetization in accordance with embodiments of this disclosure.

FIG. 5 is a block diagram of an example of a device in accordance with embodiments of this disclosure.

### DETAILED DESCRIPTION

Reference will now be made in greater detail to embodiments of the invention, examples of which are illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein. For example, the “computer” or “computing device” may include at least one or more processor(s).

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks or activities. For example, applications may perform one or more functions including, but not limited to, telephony, web browsers, e-commerce transactions, media players, streaming, Internet Protocol (IP) video, travel scheduling and management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is unless specified otherwise, or clear from context, “X includes A or B” is intended to indicate any of the natural inclusive permutations. That is if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described embodiments that are relevant for a clear understanding of the herein disclosed processes, machines, manufactures, and/or compositions of matter, while eliminating for the purpose of clarity other aspects that may be found in typical similar devices, systems, compositions and methods. Those of ordinary skill may thus recognize that other elements and/or steps may be desirable or necessary to implement the devices, systems, compositions and methods described herein. However, because such elements and steps are well known in the art, and because they do not facilitate a better understanding of the disclosed embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein are methods, apparatus and systems for content control and monetization. The system provides a platform for content owners to implement a pay per view per person when watching content and permits viewers to view the latest movies and premium content in their living rooms and home theaters. For example, viewers or user can watch first day, first watch shows from their home.

In an implementation, the system permits the content owners to charge viewers for watching content and generate revenue each time the content is viewed and by the number of viewers. The content owners may set prices based on the number of times the content may be viewed, the number of viewers consuming the content, and the period of time that the content is available for viewing. In an implementation, the system permits the viewer to purchase when the content is to be available, the number of viewers, the number of views, and other like features.

In an implementation, the system permits the content owners to restrict viewing to authorized viewers. For example, the content should not be played if the number of actual viewers exceeds the number of viewers authorized to view the content. The content may be paused if an additional viewer tries to view the content while playing and the inclusion of the additional viewer exceeds the number of authorized viewers.

In an implementation, the system may use anti-piracy techniques to prevent copying or recording of the content from delivery of the content to playing of the content. That is, the system provides an end-to-end method for protecting the content. This may include encryption using blockchain, temporal keys, and playback via High-bandwidth Digital Content Protection (HDCP) as the content traverses connections such as DisplayPort (DP), Digital Visual Interface (DVI), High-Definition Multimedia Interface (HDMI), and the like. In an implementation, the system may incorporate invisible or human imperceptible watermarks and flicker (which would be picked up by a camera) to thwart attempts to record or copy the content via a camcorder or similar recording devices. For example, the content player may display an invisible watermark to uniquely identify the device for purposes of tracing a source of the pirated copies or recordings.

In an implementation, a secure HDMI dongle, set top box (STB), or a Smart TV application may receive the encrypted content from a content headend such as an Internet Protocol (IP) server, satellite, cable, and the like and render on a display device. An audience measurement device may be connected to the display device, the secure HDMI dongle, the STB, or a Smart TV to measure the number of viewers watching the content. The audience measurement may use optical (i.e., camera, Intel® RealSense™ technologies (Intel and RealSense are trademarks of Intel Corporation), and the like) or non-optical (i.e., sonar, Wi-Fi measurements and the like) methods to measure the number of viewers watching the content. The audience measurement device may uniquely identify the viewers based on face recognition, iris scanning, and the like. In an implementation, the audience measurement device may differentiate between non-human animals, pets, babies, and the like. In an implementation, machine learning may be used to differentiate between different objects.

In an implementation, secure silicon (with keys embedded in the decoder (which may be the content playing device, the display device, the secure HDMI dongle, the STB, or a Smart TV)) may be used to encrypt/decrypt each stream separately for each device with specific keys so that the common problem of one key being compromised would not allow all the content to be decoded. In an implementation, the decoder may include a digital rights management (DRM) system.

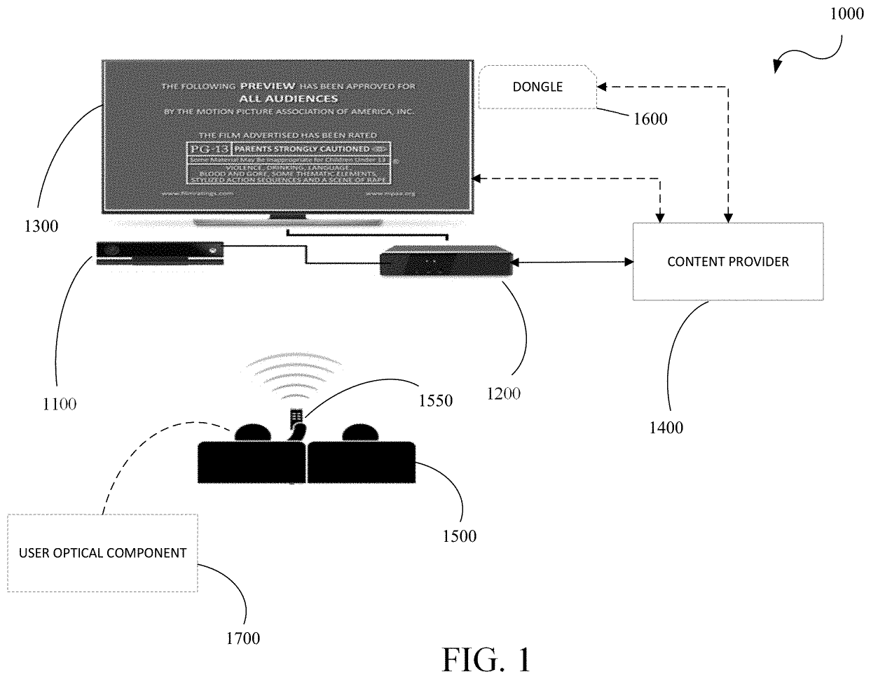

FIG. 1 is a diagram of an example architecture of a system 1000 in accordance with embodiments of this disclosure. System 1000 includes an audience measurement device 1100 connected to or in communication with (collectively “connected to”) a content receiving device 1200. The content receiving device 1200 may be, but is not limited to, a set top box, a computing device, and the like. The content receiving device 1200 may be connected to a display device 1300, which may be, but is not limited to, a television, monitor, or display. The content receiving device 1200 may be further connected to a content provider 1400, where the content provider 1400 may include any source, media, or platform which provides content. In an implementation, the audience measurement device 1100 and the content receiving device 1200 may be an integrated device. The connections described in the specification may be wired, wireless, or a combination thereof. The system 1000 is illustrative and may include additional, fewer or different devices, entities and the like which may be similarly or differently architected without departing from the scope of the specification and claims herein. Moreover, the illustrated devices may perform other functions without departing from the scope of the specification and claims herein.

In an implementation, the content receiving device 1200 may be a dongle 1600. In this case, the dongle 1600 may be connected to the display device 1300, the audience measurement device 1100, and may receive the content from the content provider 1400.

In an implementation, the content receiving device 1200 may be the display device 1300 when the display device 1300 is a Smart television. In this case, the display device 1300 may be connected to the audience measurement device 1100 and may receive the content from the content provider 1400.

The audience measurement device 1100 may measure the number of viewers that may be present during the playing of the content. In an implementation, the measurement may be done using optical devices such as cameras, laser-based techniques, pattern recognition, and the like. In an implementation, the measurement may be done using optical devices such as infrared cameras which have lesser degree of privacy concerns than visible wavelength cameras and devices. In an implementation, the measurement may be done using non-optical devices such as sonar, WiFi, and the like. In an implementation, the measurement may be done when the viewing of the content is initiated and on a periodic basis thereafter to check the number of viewers during the playing of the content. In an implementation, the audience measurement device 1100 may capture authorization, authentication, or verification information from the viewers to determine that one of the viewers is an authorized viewer. In an implementation, the audience measurement device 1100 may use facial recognition, biometrics, iris recognition and the like to capture the authorization, authentication, or verification information. In an implementation, the capturing may be done when the viewing of the content is initiated. In an implementation, the audience measurement device 1100 may pause playing of the content when a user is the sole viewer, and the user is not facing the display device 1300 due to, for example, answering a phone, talking to another person, or leaves a viewing area.

The content receiving device 1200 may use the information from the audience measurement device 1100 to determine if the number of viewers exceeds the number of viewers purchased with respect to the content being watched. The content receiving device 1200 may pause the playing of the content. In an implementation, the content receiving device 1200 may provide an alert or notification to the viewers of the issue. In an implementation, the alert may be an audible alert, a visual alert, or a combination thereof. In an implementation, the content receiving device 1200 may use the authorization, authentication, or verification information from the audience measurement device 1100 to determine if there is an authorized viewer. In an implementation, the determination may be done when the viewing of the content is initiated. In an implementation, the content receiving device 1200 may determine if the content has exceeded the number of views purchased by the viewer. In an implementation, the content receiving device 1200 may provide an alert or notification to the viewers of the issue. In an implementation, the alert may be an audible alert, a visual alert, or a combination thereof.

The display device 1300 displays the content. In the instance that the display device 1300 is also the content receiving device 1200, the display device 1300 may perform the functionality of the content receiving device 1200. In an implementation, the display device 1300 may work in cooperation with the content receiving device 1200.

The content provider 1400 may deliver the content via streaming, cable, satellite, wired, or wireless to the content receiving device 1200, the display device 1300, or the dongle 1600, as appropriate and applicable.

The dongle 1600 may be used to stream the content to the display device 1300. In an implementation, the dongle 1600 is also the content receiving device 1200, the dongle 1600 may perform the functionality of the content receiving device 1200. In an implementation, the dongle 1600 may work in cooperation with the content receiving device 1200.

Users 1500 may initiate watching of content using a remote control 1550. The remote control 1550 may perform functions such as, but not limited to, starting the system 1000, changing channels, controlling volume and the like. In an implementation, the users may use user optical components 1700, such as, but not limited to, 3D glasses, augmented reality (AR) glasses and the like. The user optical components 1700 may be paired with one or more of the audience measurement device 1100, the content receiving device 1200, the display device 1300, the dongle 1600, and the like. In an implementation, the pairing may be done via Bluetooth, radio-frequency identification (RFID), or the like. In an implementation, the audience measurement device 1100 may use the user optical components 1700 to determine an authorized user. In an implementation, the audience measurement device 1100 may use the user optical components 1700 to determine the number of viewers. In an implementation, the user optical components 1700 may be the display device 1300. In an implementation, the user optical components 1700 may be the display device 1300 and the content receiving device 1200. In an implementation, the user optical components 1700 may include audio and video capabilities to communicate with other user optical components 1700.

Operationally, the users 1500 may initiate the watching of a selected content. The audience measurement device 1100 and the content receiving device 1200 (collectively referring to one or more of the content receiving device 1200, the display device 1300, the dongle 1600, or the user optical components 1700) cooperatively determine if the viewer is an authorized viewer and whether the number of viewers equals or is below the number of viewers purchased. If the viewer is authorized and the number of viewers is acceptable, the content from the content provider is displayed on the display device 1300 or the user optical components 1700, as appropriate. In an implementation, playing of the content may be paused when a user is the sole viewer, and the user is not facing the display device 1300 due to, for example, answering a phone, talking to another person, or leaves a viewing area.

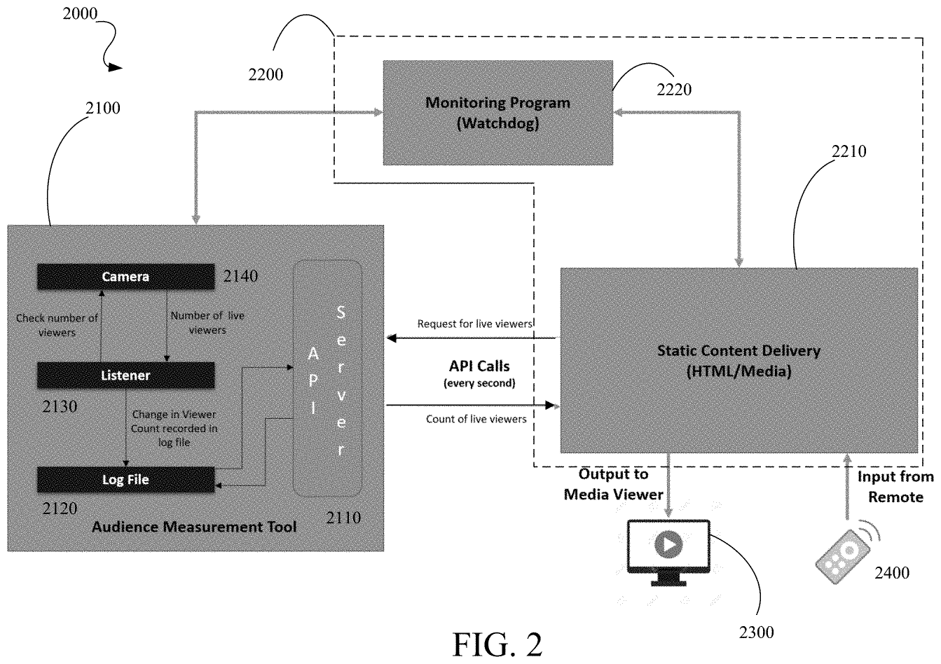

FIG. 2 is a diagram of an example hardware and software architecture 2000 of the system 1000 in accordance with embodiments of this disclosure. An audience measurement device 2100 may include a server Application Programming Interface (API) 2110 which retrieves data from a log file 2120. The data, for example, may include the number of viewers watching the content. The log file 2120 is updated by a listener module 2130, which queries a measurement device, such as a camera 2140, to determine the number of viewers. The server API 2110 is responsive to queries from a content receiving device 2200.

The content receiving device 2200 may include a content delivery module 2210 and a monitoring program 2220. The content delivery module 2210 may make API calls to the server API 2110 to obtain the number of viewers watching the content. The monitoring program 2220 determines based on input from either the audience measurement device 2100 or the content delivery module 2210, if the number of viewers reported is within a purchased number of viewers. In an implementation, monitoring program 2220 may determine whether an authorized viewer initiated the viewing of the content. In an implementation, this may be based on information obtained from the audience measurement device 2100 or viewer inputs, using for example, a remote control 2400 to enter in a password or the like.

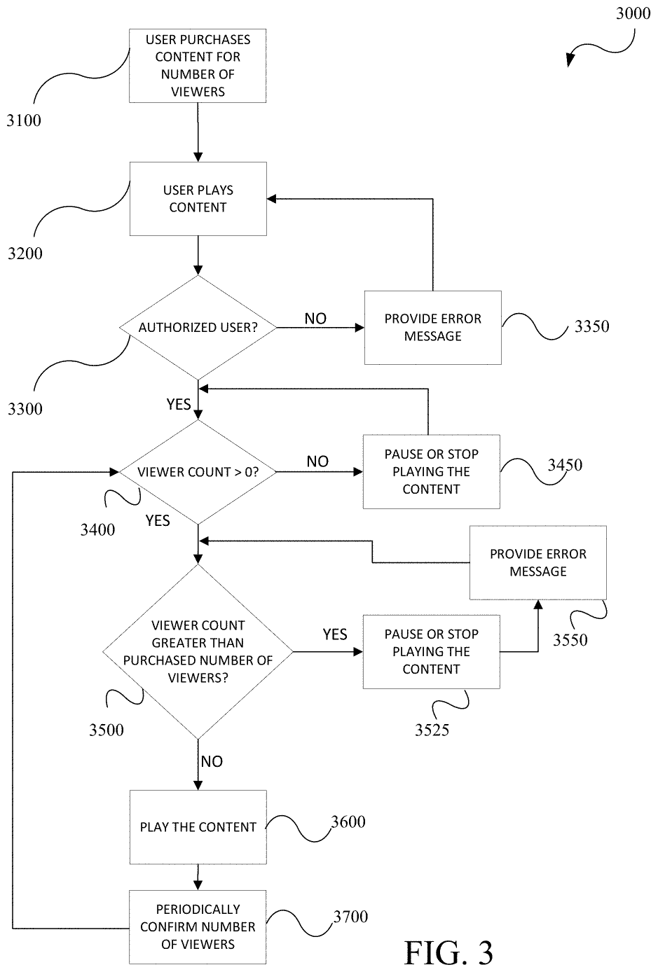

FIG. 3 is a flowchart of an example method 3000 for content control and monetization in accordance with embodiments of this disclosure. The method 3000 includes: purchasing 3100 content for a number of viewers; initiating 3200 playing of the content; determining 3300 if the viewer is authorized; providing 3350 an error message if the viewer is not authorized; determining 3400 if the number of viewers is greater than zero; pausing or stopping 3450 playing of the content if no one is viewing; determining 3500 if the number of viewers is greater than the number of viewers purchased; pausing or stopping 3525 playing of the content if too many viewers; providing 3550 an error message if too many viewers; playing 3600 the content if number of viewers is okay; and periodically confirming 3700 the number of viewers during playing of the content. For example, the method or technique 3000 may be implemented, as applicable and appropriate, by the audience measurement device 1100, the content receiving device 1200, the display device 1300, the content provider 1400, the user optical component 1700, and the dongle 1600.

The method 3000 includes purchasing 3100 content for a number of viewers. In an implementation, the viewer purchases how many times the content may be viewed and a maximum number of viewers that may watch per view. In an implementation, the purchase may be updated by adding more views or more viewers.

The method 3000 includes initiating 3200 playing of the content. In an implementation, a viewer may initiate playing a selected content by using a number of techniques including, but not limited to, using a remote control, voice activation, and the like.

The method 3000 includes determining 3300 if the viewer is authorized. In an implementation, authorization may be determined using a number of techniques including, but not limited to, biometrics, passwords, and the like. In an implementation, authorization may include that there are available purchased views left. In an implementation, authorization may include one or more of the above authorizations.

The method 3000 includes providing 3350 an error message if the viewer is not authorized. In an implementation, the error message may be displayed on the display screen. In an implementation, the error message may be audible. In an implementation, the error message may be may a combination of visual and audio error messages. In an implementation, the error message may indicate what type of error. In an implementation, the error message may indicate how to correct the error.

The method 3000 includes determining 3400 if the number of viewers is greater than zero and pausing or stopping 3450 playing of the content if no one is viewing. In an implementation, the system may determine that no one is watching and pause content playback. In an implementation, the system may resume playing when a viewer(s) returns if the other considerations described in the specification are satisfied. In an implementation, the determining 3400 includes obtaining how many viewers are watching. In an implementation, this may be done using optical techniques, non-optical techniques, and non-privacy invasive optical techniques. In an implementation, an error message may be provided as described in the specification.

The method 3000 includes determining 3500 if the number of viewers is greater than the number of viewers purchased. In an implementation, the determining 3500 includes obtaining how many viewers are watching. In an implementation, this may be done using optical techniques, non-optical techniques, and non-privacy invasive optical techniques.

The method 3000 includes pausing or stopping 3525 playing of the content if too many viewers and providing 3550 an error message if too many viewers. In an implementation, the error message may note that there are too many viewers. In an implementation, the error message may be visual, audible, or a combination thereof. In an implementation, the error message may note that additional viewers may be purchased. In an implementation, the error message may provide a link, button, or the like to purchase additional viewers.

The method 3000 includes playing 3600 the content if number of viewers is okay.

The method 3000 includes periodically confirming 3700 the number of viewers during playing of the content. This ensures that the number of viewers is in line with the number of viewers purchased during the playing of the content. In an implementation, the playing of the content may be paused when a user is the sole viewer, and the user is not facing the display device 1300 due to, for example, answering a phone, talking to another person, or leaves a viewing area.

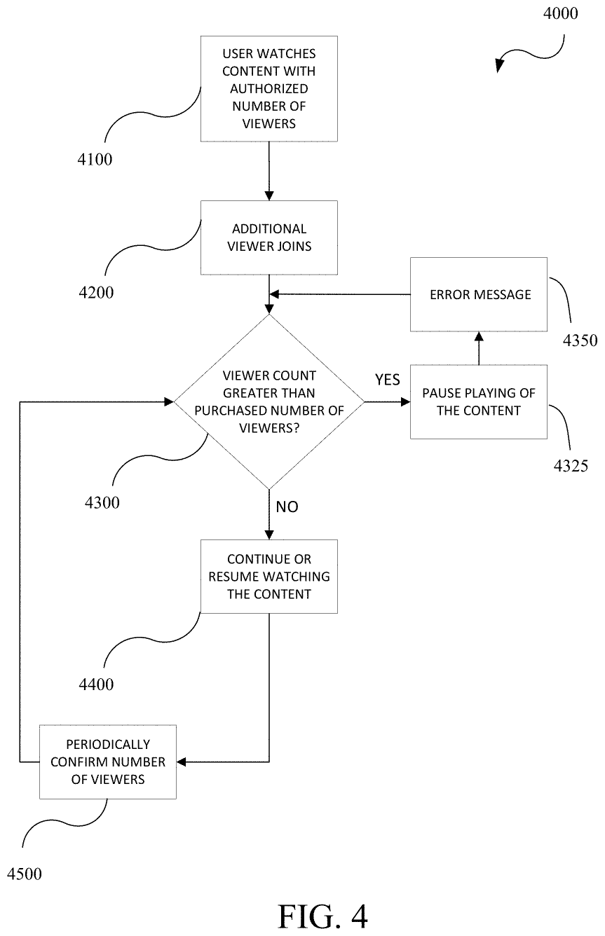

FIG. 4 is a flowchart of another example method for content control and monetization in accordance with embodiments of this disclosure. The method 4000 includes watching 4100 the content with an approved number of viewers; detecting 4200 an additional viewer has joined; determining 4300 if the number of viewers is greater than the number of viewers purchased; pausing or stopping 4325 playing of the content if too many viewers; providing 4350 an error message; continuing or resuming 4400 playing of the content of if the number of viewers meets or is below the purchased number of viewers; periodically confirming 4500 the number of viewers. For example, the method or technique 3000 may be implemented, as applicable and appropriate, by the audience measurement device 1100, the content receiving device 1200, the display device 1300, the content provider 1400, the user optical component 1700, and the dongle 1600.

The method 4000 includes watching 4100 the content with an approved number of viewers. The watching 4100 includes purchasing content for a number of viewers. In an implementation, the viewer purchases how many times the content may be viewed and a maximum number of viewers that may watch per view. In an implementation, the purchase may be updated by adding more views or more viewers. The watching 4100 includes determining the number of viewers is not greater than the number of viewers purchased. In an implementation, the watching 4100 includes determining that the viewer is authorized. In an implementation, authorization may be determined using a number of techniques including, but not limited to, biometrics, passwords, and the like. In an implementation, authorization may include that there are available purchased views left. In an implementation, authorization may include one or more of the above authorizations.

The method 4000 includes detecting 4200 an additional viewer has joined. In an implementation, optical, non-optical and non-optical privacy impacting techniques may be used to determine the presence of a viewer.

The method 4000 includes determining 4300 if the number of viewers is greater than the number of viewers purchased, pausing or stopping 4325 playing of the content if too many viewers, and providing 4350 an error message. In an implementation, the error message may note that there are too many viewers. In an implementation, the error message may be visual, audible, or a combination thereof. In an implementation, the error message may note that additional viewers may be purchased. In an implementation, the error message may provide a link, button, or the like to purchase additional viewers.

The method 4000 includes continuing or resuming 4400 playing of the content if the number of viewers meets or is below the purchased number of viewers.

The method 4000 includes periodically confirming 4500 the number of viewers. This ensures that the number of viewers is in line with the number of viewers purchased during the playing of the content. In an implementation, playing of the content may be paused when a user is the sole viewer, and the user is not facing the display device 1300 due to, for example, answering a phone, talking to another person, or leaves a viewing area.

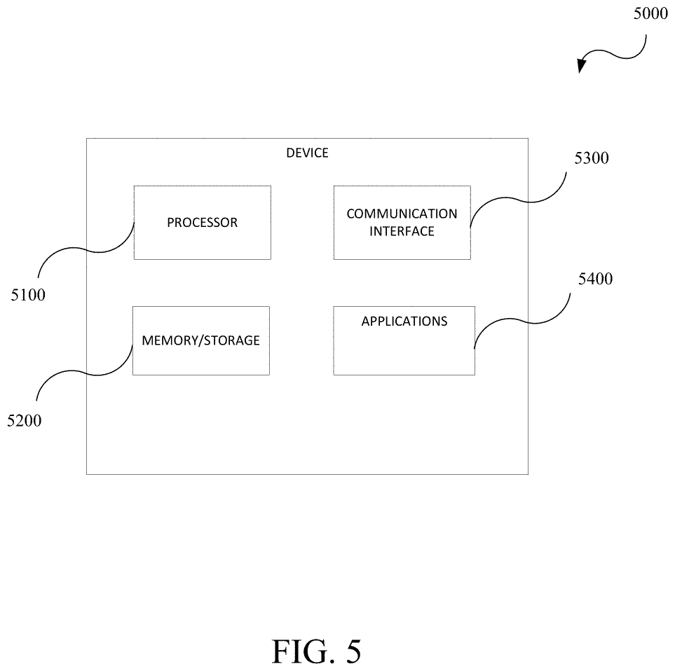

FIG. 5 is a block diagram of an example of a device 5000 in accordance with embodiments of this disclosure. The device 5000 may include, but is not limited to, a processor 5100, a memory/storage 5200, a communication interface 5300, and applications 5400. The device 5000 may include or implement, for example, the audience measurement device 1100, elements of the system 1000, the IP video application server 5210, the location server 5230, the channel mapping unit 5220, the content receiving device 1200, and the display device 1300. In an implementation, the memory/storage 5200 may store the number of viewers purchased, authentication or verification information, and the like. The content control and monetization techniques or methods described herein may be stored in the memory/storage 5200 and executed by the processor 5100 in cooperation with the memory/storage 5200, the communications interface 5300, and applications 5400, as appropriate. The device 5000 may include other elements which may be desirable or necessary to implement the devices, systems, compositions and methods described herein. However, because such elements and steps are well known in the art, and because they do not facilitate a better understanding of the disclosed embodiments, a discussion of such elements and steps may not be provided herein.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more the computer readable mediums having the computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain embodiments, it is to be understood that the disclosure is not to be limited to the disclosed embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for controlled content display, the method comprising:
obtaining, by an audience determination device, a number of viewers watching a selected content being played on a display device;
determining, by a content receiving device, if the determined number of viewers exceeds a purchased number of viewers;
pausing, by the content receiving device, the playing of the selected content on the display device when the determined number of viewers exceeds the purchased number of viewers;
providing, by the content receiving device, an error message when the determined number of viewers exceeds the purchased number of viewers; and
resuming, by the content receiving device, playing of the selected content when the determined number of viewers does not exceed the purchased number of viewers.

2. The method of claim 1, wherein the error message provides a selection button to increase the purchased number of viewers.

3. The method of claim 1, further comprising:
determining, by the content receiving device, if there is at least one purchased view for the selected content; and
providing, by the content receiving device, an error message when there is no available purchased view.

4. The method of claim 3, wherein the error message provides a selection button to increase the purchased views.

5. The method of claim 1, further comprising:
determining, by the content receiving device, that an authorized viewer is present; and
providing, by the content receiving device, an error message when the authorized viewer is absent.

6. The method of claim 5, further comprising:
obtaining, by an audience determination device, authorized viewer information.

7. The method of claim 1, further comprising:
determining, by the content receiving device, an absence of viewers; and
pausing, by the content receiving device, the playing of the selected content on the display device.

8. The method of claim 1, further comprising:
periodically determining, by the content receiving device, the number of viewers during playback of the selected content.

9. A method for controlling content display, the method comprising:
monitoring, by a content receiving device, a number of viewers watching a selected content being played on a display device;
pausing, by the content receiving device, the playing of the selected content on the display device when the determined number of viewers exceeds the purchased number of viewers;
alerting, by the content receiving device, to the number of viewers that a determined number of viewers exceeds the purchased number of viewers; and
resuming, by the content receiving device, playing of the selected content when the determined number of viewers and the purchased number of viewers are at least equal.

10. The method of claim 9, wherein the monitoring comprises:
obtaining, by an audience determination device, the number of viewers watching the selected content being played on a display device; and
determining, by the content receiving device, if the determined number of viewers exceeds the purchased number of viewers;

11. The method of claim 9, wherein the alerting comprises:
providing an option to increase the purchased number of viewers.

12. The method of claim 9, further comprising:
determining, by the content receiving device, availability of a purchased view for the selected content; and
alerting, by the content receiving device, to a viewer that there is no available purchased view.

13. The method of claim 12, wherein the alerting comprises:
providing an option to increase the purchased views.

14. The method of claim 9, further comprising:
determining, by the content receiving device, that an authorized viewer is initiating the playback of the selected content; and
alerting, by the content receiving device, a viewer that they are not an authorized viewer.

15. The method of claim 14, wherein authorization information is captured by an audience measuring device.

16. The method of claim 9, further comprising:
periodically determining, by the content receiving device, the number of viewers during playback of the selected content.

17. An apparatus comprising:
a display device configured to display selected content;
an audience measurement device configured to capture viewer data; and
a content receiving device connected to the audience measurement device and the display device, wherein the content receiving device is configured to:
determine if a number of viewers from the viewer data exceeds a purchased number of viewers for the selected content;
pause playback of the selected content on the display device;
notify the number of viewers why the playback is paused; and
resume the playback when the number of viewers matches or is below the purchased number of viewers.

18. The apparatus of claim 17, wherein the viewer data further includes authorization data, and wherein the content receiving device is configured to:
determine if the authorization data matches one of the number of viewers; and
notify the number of viewers of unauthorized view if no authorized viewer is present.

19. The apparatus of claim 17, wherein the content receiving device is configured to:
determine if purchased views are available for the selected content; and
provide an option to increase the purchased views.

20. The apparatus of claim 19, wherein the content receiving device is configured to:
periodically determine the number of viewers during playback of the selected content.
